(19) United States
(12) Patent Application Publication
(10) Pub. No.: US 2006/0218110 A1
(43) Pub. Date: Sep. 28, 2006

(54) Method for deploying additional classifiers

(76) Inventors: Steven J. Simske, Fort Collins, CO (US); David W. Wright, Stoneham, MA (US); Margaret M. Sturgill, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/091,122

(22) Filed: Mar. 28, 2005

(51) Int. Cl. G06F 15/18; G06N 5/00; G06F 17/00

(52) U.S. Cl. 706/45; 706/12

(57) ABSTRACT

A method for deploying an additional document classifier engine into an existing document processing system that includes the steps of adding a new document classifier engine to an existing single or pool of document classifier engines and training the new document classifier engine on previously misclassified documents.

### BACKGROUND

The proliferation of network technology, such as the Internet, has made it possible for users to access a large amount of electronic documents via search engines and other methods. At the same time, there has been a proportional rapid expansion in the amount of data that is stored electronically on various networks, including the Internet. As a result, there is an increasing need for automatic intellectual operations, such as classifying large collections of document data into meaningful categories. Document classification is an important step in a variety of document processing tasks such as archiving, indexing, re-purposing, data extraction, or other automated document understanding tasks. Indeed, computer network technology, such as the Internet, Intranets, wide area networks, local area networks, or other suitable network technology, is reliant on document classification for processing the multitude of documents that are being generated and added to the network each and every day.

Document classification comprises the grouping of documents that have commonality, such as, for example, similar topics, concepts, ideas and subject areas. For example, depending on the level of detail desired, “bank loan” documents may be grouped together and “auto damage claim” documents may be grouped together. Relying on a computer, however, to provide document classification in this way is perilous because computers are historically poor at these types of heuristic tasks. This limitation may be overcome by employing what are known in the art as “classifier engines” to aid the computers in the task of classifying documents. Classifier engines are software algorithms that predict how a new document should be classified based on shared topics, concepts, ideas, and subject areas of previously classified documents, i.e., “ground truth” documents. One or more classifier engines may be used in a single application. When multiple classifier engines are used, the predicted classification for a new document is computed from the pool of classifier engines by using some combination scheme, voting, or other “meta-algorithmic” scheme of combination, as is known in the art. In some multi-engine applications, the classifier engines are “weighted” relative to each other to generate optimal results (i.e., least number of misclassified or unclassified documents). In either case (i.e., one or multiple classifier engines), the result is a ranked set of predicted classifications for the new document, with the classification considered most likely ranked first, and so forth.

While the use of a single classifier engine is adequate for some applications, the use of multiple classifier engines, combined in either a series or parallel configuration, is generally more robust and results in more accurate classification of a large number of diverse document types. That is, generally, there are less misclassified or unclassified documents. However, drawbacks still exist.

As document collections grow, the size and diversity of the documents in the collections also typically grow. When this happens, existing classifier engines that are already in place in a given application may become inadequate to achieve adequate classification accuracy. One solution to this problem is to add one or more new classifier engines to the existing set of classifier engines in the application, where the new classifier engine(s) increase the efficiency and accuracy of the overall classification process. The addition of a new classifier engine to an existing system is a relatively costly proposition—both in terms of time and money—as it typically involves “retraining” the entire pool of classifier engines on the existing ground truth documents and may also require modifying or “tuning” the relative weightings of the various classifier engines. As a result, additional hardware costs may be incurred and the existing ground truth documents (which had already been properly classified) may be subject to misclassification.

The embodiments described hereinafter were developed in light of this situation and the drawbacks associated with existing systems.

### BRIEF DESCRIPTION OF THE DRAWINGS

The present embodiments will now be described, by way of example, with reference to the accompanying drawings, in which:

FIG. 1 is a block diagram that illustrates a document processing system using a single classifier engine;

FIG. 2 is a block diagram that illustrates a document processing system using multiple classifier engines;

FIG. 3 is a block diagram that illustrates a document processing system according to an embodiment; and

FIG. 4 is a flow diagram illustrating the steps for implementing a new classifier engine in the document processing system according to an embodiment.

### DETAILED DESCRIPTION

An improved method of deploying new classifier engines to an existing document processing system already having one or more classifier engine(s) is provided. An additional classifier engine may be added to an existing document processing system having either a single classifier engine or a pool of classifier engines to improve the efficiency of the system. The improved method allows the additional classifier engine to be added to the existing classifier engines in a way that the entire pool of classifying engines does not have to undergo a retraining procedure. Additionally, the new classifier engine does not have to be trained against the entire set of ground truth documents. Rather, the new classifier engine is trained by allowing the new classifier engine to classify documents that had been previously misclassified by the existing pool of classifier engines. In this manner, the new classifier engine may be optimally trained, and, at the same time, the misclassified documents may be correctly processed without having to retrain the entire pool of classifier engines.

As indicated above, “indexing” is one document processing task that benefits from an initial document classification. “Indexing” a document involves an analysis of the document content in light of the predicted classification. The indexing system extracts salient, actionable fields from the new document (using one or more commercially available software programs for extracting data from a document) and compares them to fields from existing ground truth documents within the predicted classification. The system determines that the initial predicted classification of the new document is correct if a sufficient number of the extracted fields match the fields in the collection of ground truth documents of the predicted classification. If the initial classification prediction is incorrect (i.e. not enough actionable fields match those of the ground truth documents within the predicted classification), the system may try to analyze the document in light of an alternative classification (if processing and time resources allow), or, alternatively, assign the document to a manual correction set. New documents that are assigned to the manual correction set are subsequently manually classified and indexed. Increasing the number of possible classifications through the use of multiple classifier engines increases the likelihood that the initial prediction will be correct, which makes the entire classification and indexing process more efficient.

The method of adding a new classifier engine to a pool of existing classifier engines in a document processing system can be applied to a number of document applications, including (as indicated above) archiving, indexing, re-purposing, data extraction, or other automated document understanding tasks. For purposes of simplicity, the method will be described in connection with an “indexing” document processing system, though it will be appreciated that the described method can be used in a wide variety of settings where a new classifier engine is added to one or more existing classifier engines in a system.

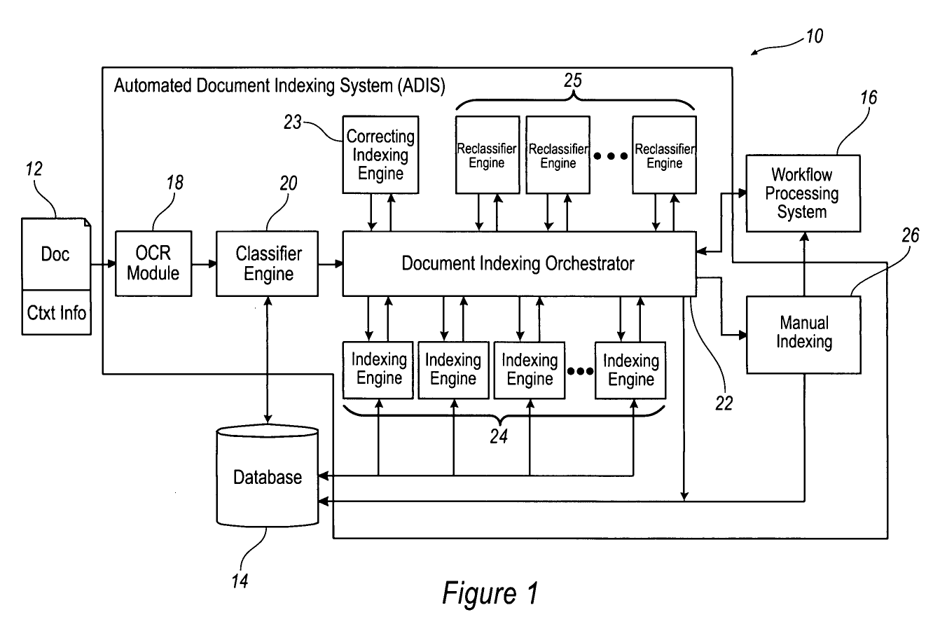

FIG. 1 is a functional block diagram of a known exemplary “indexing” document processing system 10. The indexing system 10 may reside in a network server or other computing device that includes a processor for executing the functions of indexing system 10, as well as a memory device for storing a database of documents. As shown in FIG. 1, each block represents a module, object, or other grouping or encapsulation of underlying functionality as implemented in program code. However, the same underlying functionality may exist in one or more modules, objects, or other groupings or encapsulations that differ from those in FIG. 1 without departing from the embodiments described within.

The exemplary indexing system 10 illustrated in FIG. 1 is configured to receive a document 12 and classify document 12 for storage in a database 14 or for application in a particular workflow processing system 16. Indexing system 10 includes a number of components for the indexing of documents, such as an optical character recognition (OCR) engine 18 and a classifier engine 20. Indexing system 10 also includes a document indexing orchestrator 22 and a plurality of indexing engines 24. Indexing orchestrator 22 directs the use of various indexing engines 24 in order to extract indices, i.e., data fields, from a respective document 12. Indexing engines 24 may comprise, for example, any one of a number of commercially available programs for extracting indices from document 12 that employ technologies such as natural language processing, neural networks, Bayesian analysis, and other technologies.

Indexing system 10 further includes a manual indexing module 26 that is employed to manually extract indices from document 12 when the indexing orchestrator 22 fails. In addition, indexing orchestrator 22 communicates with workflow processing system 16 to provide indexed documents 12 thereto for processing according to the respective workflow of workflow processing system 16. Various components of indexing system 10 interface with database 14 to obtain such information as is necessary to perform their functions. Also, indexing engines 24 sequentially attempt to index new documents according to the predicted classification ranking described above.

Database 14 includes a collection of ground truth documents that have been previously classified and now are organized (i.e., grouped together or associated with each other) according to a number of classifications. Within a given classification, the ground truth documents include similar characteristics or traits. Associated with each of the ground truth documents are data fields, i.e., “indices”, and contextual information. The data contained within each data field may be used as “key” information about the document to organize and/or subsequently search for ground truth documents within database 14. For example, one index may include a “Name” data field with a corresponding value of “John Doe.” The indices associated with each ground truth document act as a metadata that facilitates a search for each ground truth document so that they may be retrieved at a later date in a speedy and economical manner for use in activating workflows downstream, or what is know in the art as “auto-processing.”

The general operation of exemplary indexing system 10 will now be described according to the various embodiments. First, an electronic document is introduced to the indexing system 10. The electronic document may be introduced in a variety of ways. For example, if an electronic version of a new document is available, it can be used directly. If only a hard copy of a new document is available, the hard copy may be scanned to create a digital image of the hard copy document. In addition, any contextual information that is generated during the document production stage is associated with document 12. The contextual information may comprise, for example, a name of a user that produced document 12 using the document producing equipment, a time at which document 12 was produced by the equipment, or other information, as may be appreciated. The contextual information may be associated with document 12 by including the contextual information as metadata associated with document 12 in some manner, as is known by those skilled in the art.

Once in a digital format, document 12 is applied to OCR engine 18, if necessary, to convert any text in document 12 that is represented in image format into recognizable text. After any image data in the document is converted to searchable text, document 12 is applied to classifier engine 20, which predicts an appropriate classification for document 12. Thus, an association is drawn between document 12 (to be subsequently indexed) and one of the existing classifications. Further, classifier engine 20 may generate a list of classifications that is ordered according to the likelihood that the new document appropriately falls within each classification. For example, the more likely document 12 is properly classified in a given classification, the higher the priority assigned to the classification in the list. Initially, document 12 is classified as belonging to the highest priority classification on the list. As known by a person skilled in the art, classifier engine 20 may employ winnowing algorithms, predefined rules (e.g., assigning all documents entered by a billing clerk to one particular classification), and other techniques to predict an appropriate classification for the new document 12.

Once a classification is predicted for new document 12, it is applied to document indexing orchestrator 22. Indexing orchestrator 22 applies document 12 to one or more of indexing engines 24 (employing various known algorithms) to extract indices from document 12. As described above, the indices comprise data fields with corresponding data values that are associated with document 12 and that are used to organize, search and perform other functions on document 12 and the other ground truth documents in database 14. Further, the data associated with the indices may be employed in a workflow process and indexing may also be used to validate, activate downstream workflows, etc., as known by persons skilled in the art. A variety of algorithms and techniques can be used with respect to the indexing engines 24 to determine if the predicted classification of the new document was correct. For example, if the indexing engines 24 successfully extract data from a sufficient number of the same indices as exist in the ground truth documents for the predicted classification, then it is determined that the original predicted classification is correct. If not, various other algorithms and techniques may be employed to classify and ultimately index the new document. If all else fails, then the new document 12 may be addressed by the manual indexing module 26.

If indexing orchestrator 22 determines that the predicted classification is correct, then the indexing engines 24 index the new document 12, and the data extracted from the indices in the new document may be placed in an appropriate header or other data structure associated with document 12. The new document 12 may then be automatically applied to workflow processing system 16 for further processing based upon a predefined workflow.

Workflow processing system 16 may employ the values associated with the indices to perform a predefined workflow. For example, workflow processing system 16 may comprise a bank loan approval system. Various ones of the indices may comprise, for example, the name of a lender, a loan amount, and other information pertinent to obtain the approval of a loan. Workflow processing system 16 may then proceed to automatically determine whether the loan is approved based upon predetermined criteria. If document 12 has been incorrectly classified and/or the specific indices associated with document 12 are not those expected by workflow processing system 16, then workflow processing system 16 returns document 12 back to indexing orchestrator 22 for reclassification in order to perform further attempts to extract indices from document 12.

If the indexing orchestrator 22 determines that the initial predicted classification was incorrect (e.g., unable to match a sufficient number of indices from the new document to the indices of the ground truth documents in the predicted classification), then indexing orchestrator 22 may apply document 12 to a correcting indexing engine 23 and then reclassifier engines 25, as known in the art, to further attempt to properly reclassify document 12. If the reclassification(s) of document 12 still fails, prior solutions involved placing document 12 in a manual queue to be accessed by manual indexing module 26 to facilitate the manual extraction of the indices from document 12.

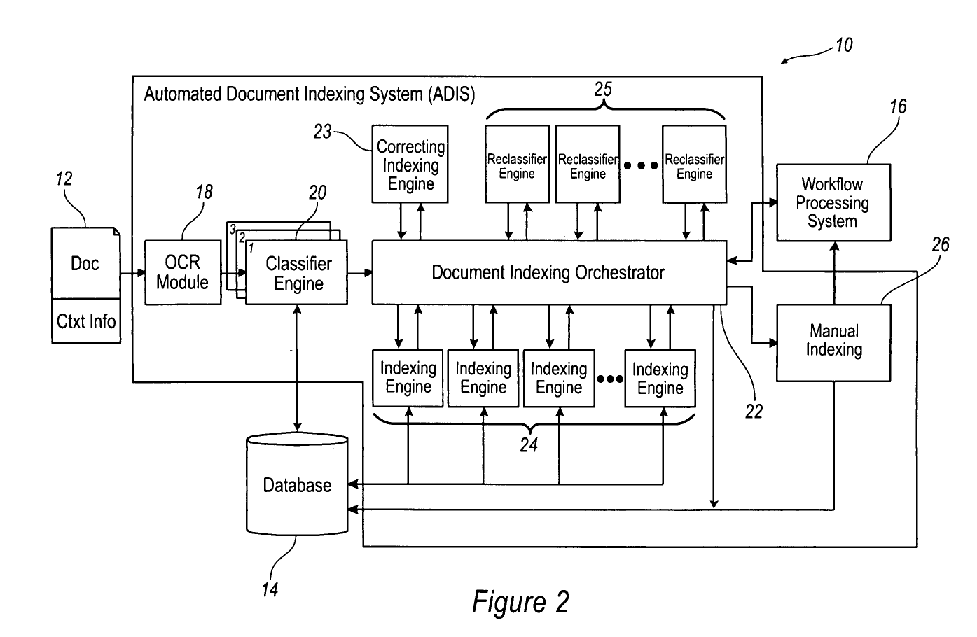

FIG. 2 illustrates an indexing system 10 that improves upon the accuracy of the initial predictive classification of new documents 12. Specifically, the embodiment of the indexing system 10 in FIG. 2 includes multiple classifier engines 20. Multiple classifier engines 20 may be employed in series and/or parallel combinations known as “meta-algorithmics.” As known in the art, employing multiple classifier engines 20 generally not only increases the speed of document classification, it also increases the universe of available classifications, and, consequently, the likelihood that a new document 12 will fall into a given classification and be properly classified by the system. Moreover, the addition of multiple of classifier engines 20 typically improves the relative classification rank of the “best” classification (even if not 100% accurate)—known in the art as “improving the central tendency” of the classification—which at least increases the likelihood that indexing engines 24 will extract the correct indices and properly index the new document 12. The more accurate the initial classification prediction, the more efficient and accurate is the downstream indexing process in indexing system 10. As a result, less documents need to be manually classified and/or indexed.

The description of an exemplary indexing system 10 thus far has been of indexing systems that employ either single or multiple classifier engines 20 that were implemented simultaneously, and with the classifier engines 20 being trained on the same set of documents upon the initialization of the particular indexing system. In other words, the classifier engines 20 were launched with their respective indexing systems. Additional details relating to such indexing systems are set forth in commonly-assigned U.S. patent application Ser. Nos. 10/916,877; 10/916,942; and 10/916,878, all of which are hereby incorporated by reference.

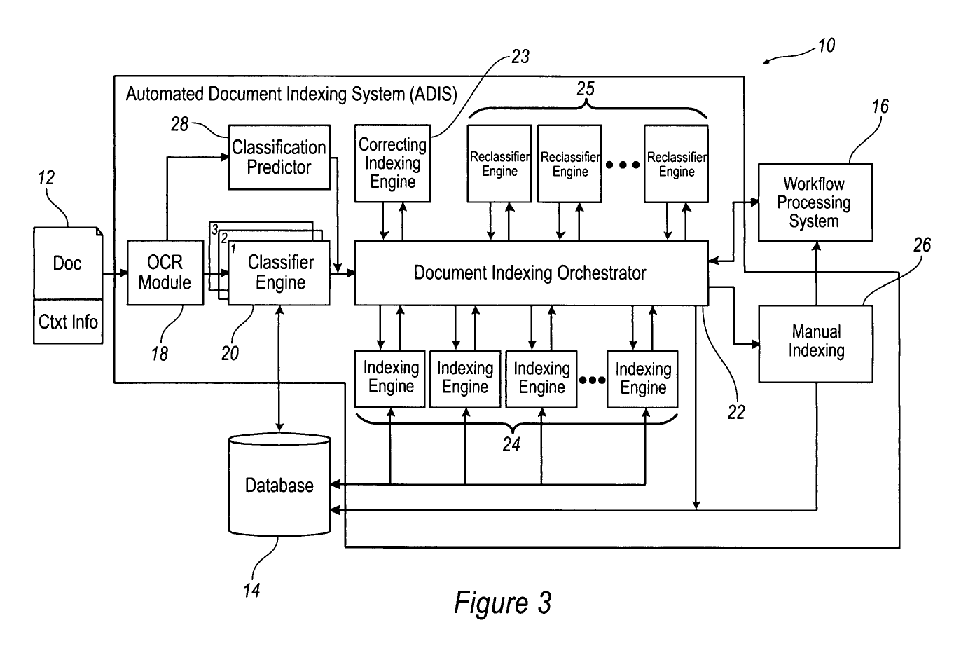

Now, a method of adding a new classifier engine 20 to one or more classifier engines 20 in an existing system will be described. FIG. 3 illustrates an indexing system 10 according to an embodiment. This particular indexing system 10 is the same as the system shown in FIG. 2, except that it includes a classifier engine 28 that has been added to the existing pool of classifier engines 20 at a time subsequent to when classifier engines 20 had already been trained. According to this embodiment, classifier engine 28 is added to system 10 and trained on documents that had been previously misclassified or unclassified by the existing pool of classifier engines 20. The new classifier engine 28 is not trained on the entire collection of ground truth documents in the data base, as with previous methodologies and systems.

This method of training the new classifier engine 28 on previously misclassified or unclassified documents results in more efficient classification without the costs (both time and money) associated with retraining all of the classifier engines 20 and/or training the new classifier engine 28 on the entire collection of truth documents in the data base. For example, prototype test results have shown that with a new classifier engine tuned to misclassified documents, the mean number of documents classified correctly was 12724 out of 15997 documents. This may be compared to the 12461 out of 15997 documents that were classified correctly when a new classifier engine was tuned to the entire set of 15977 documents. The error rate was thus reduced from 22.1% to 20.5% by training the new classifier to the misclassified documents only, rather than the entire set of documents. Also, the new classifier was introduced to the indexing system without relatively weighting the new classifier with respect to the existing classifiers.

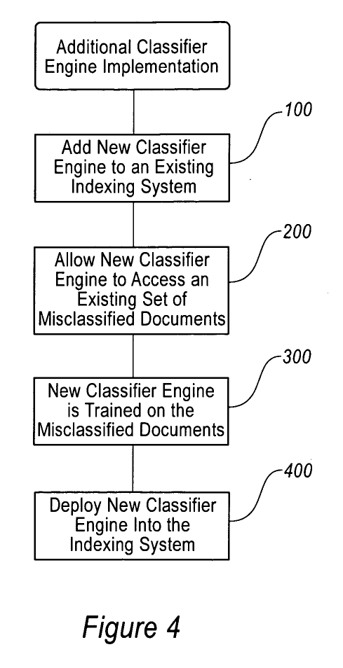

FIG. 4 sets forth an exemplary methodology for adding an additional classifier engine 28 to one or more classifier engines 20 in an existing indexing system 10. Classifier engine 28 is typically a software program that may be readily added to any indexing system at step 100 and may be trained within indexing system 10 in the following manner. Classifier engine 28 is allowed access to an existing set of misclassified documents contained within indexing system 10 at step 200. Classifier engine 28 is trained to optimally solve the misclassified set of documents at step 300 by generating new lists of predicted classifications. Once classifier engine 28 is properly trained, it may be deployed with the settings as determined in step 200 into indexing system 10 along with classifier engines 20 at step 400. The steps of adding a new classifier may be implemented on a controller, such as a microprocessor.

The addition of a new classifier to an existing set of classifiers in the indexing system in this manner increases the speed of deployment and lowers the overall system cost for the indexing system. By allowing the new classifiers to be trained on the misclassified documents, the existing classifiers in the system may avoid retraining or changes in settings that may disrupt or cause classification errors in a typical classifying engine. Also, similar or even improved results may be obtained without relative confidence weights so that the relative overall confidence weightings for the classifier engines are not required to be calculated. The new classifiers may be tuned specifically to the set of documents that were misclassified by the existing, in-place classifier engines to avoid attempting to optimize both the new and existing classifiers to the entire ground truth document set. In this way, new classifier engines may almost always benefit the overall classification system.

In some cases, however, adding a new classifier to an existing system of multiple classifiers will need to take into account the fact that the set of engines in place may be considerably more reliable than the new engine. Although tuning the new engine to the misclassified documents may improve results without relative confidence weights so that the relative overall confidence weightings for the classifier engines are not required to be calculated, this does not preclude the system attempting to estimate such relative weights for the purpose of obtaining an even better system performance. When the engines in place are already at or above a benchmark “high” level of performance, it may be desirable to establish confidence in the new engine relative to the “in place” set of engines. Accordingly, relative weightings can be determined for the various engines, which can be computed without training on the entire set of ground truth documents. Instead, a representative small set (for example, 5-10% of the ground truth set) of “targeted ground truth” documents (documents representing all of the classification types, but in relatively small sets) can be used to gauge the relative confidence of the new engine and existing set of engines. These confidence values can then be applied uniformly to the new and existing engines. In general, this will result in a lower relative weight for the new engine, but may provide improved overall system behavior in cases in which the new “added” engine is poorer in quality than the “in place” engines.

Overall, the cost of deploying an additional classifier into a meta-algorithmic combination is greatly reduced. The market for new classifier engines is emerging and a number of new technologies and techniques are being introduced to the field. Customers who adopt meta-algorithmic solutions will expect the ability to incorporate new classifier technologies as they become available. As the classifier technology evolves, the new classifiers may be deployed in existing systems with a minimal impact on the in place classifiers. The new classifiers may be deployed without degrading the entire system.

While the present invention has been particularly shown and described with reference to the foregoing preferred embodiment, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method for deploying an additional document classifier engine into an existing document processing system having at least one existing classifier engine:
adding a new document classifier engine to the system; and
training said new document classifier engine on a collection of documents previously misclassified by the existing document processing system.

2. The method of claim 1, further comprising the step of weighting said new document classifier engine relative to the at least one existing classifier engine.

3. The method of claim 2, wherein said weighting step is based upon a subset of a full set of ground truth documents.

4. The method of claim 1, wherein said training of said new document classifier occurs without retraining of the at least one existing classifier engine.

5. A system for processing documents, comprising:
a computing device having a processor and a memory;
a database stored in said memory, said database including a plurality of ground truth documents organized in a plurality of classifications and a plurality of misclassified documents;
a first classifier engine; and
a second classifier engine, added to the system subsequent to said first classifier engine, said second classifier engine being configured to be trained on said plurality of misclassified documents.

6. The system of claim 5, further comprising means for indexing documents in light of a classification associated with said documents.

7. A processor-readable medium having instructions thereon for deploying an additional document classifier engine into an existing document processing system having at least one existing classifier engine, said instructions being configured to instruct a processor to perform the steps of:
adding a new document classifier engine to the system; and
training said new document classifier engine on a collection of documents previously misclassified by the existing document processing system.

8. The processor-readable medium of claim 7, further having instructions thereon for performing the step of weighting said new document classifier engine relative to the at least one existing classifier engine.
